(19) United States
(12) Patent Application Publication
(10) Pub. No.: US 2005/0286273 A1
(43) Pub. Date: Dec. 29, 2005

(54) Self-drive for synchronous rectifiers

(76) Inventor: Andrew Ferencz, Southborough, MA (US)

Correspondence Address: JAMES K. WEIXEL, ESQ.;BOWDITCH & DEWEY, LLP, 161 Worcester Road, P.O. Box 9320, Framingham, MA, 01701-9320, US

(21) Appl. No.: 11/007,675

(22) Filed: Dec. 8, 2004

Related U.S. Application Data
(60) Provisional application No. 60/583,142, filed on Jun. 25, 2004.

(51) Int. Cl. H02M 3/335

(52) U.S. Cl. 363/21.06

(57) ABSTRACT

A system and method for providing the self-drive of synchronous rectifiers used in isolated power converters is provided. A transformer having a primary winding, a secondary winding and a drive winding is used between a front end connected to a source and a back end coupled to a load. The primary winding is coupled to the source and the secondary winding is coupled to the back end which in turn is coupled to the load. The drive winding is magnetically coupled to the primary winding by way of a turns ratio. The output of the drive winding is used to reliably control the gates of MOSFETs used in the back end. The drive winding can be configured to output voltages sufficient to reliably turn the MOSFETs on over the entire operating range of the power converter. In addition, use of a drive winding simplifies construction of the back end by reducing the number of electronic components needed in the back end.

### CROSS REFERENCES TO RELATED APPLICATIONS

The present application claims the benefit of U.S. Provisional Application No. 60/583,142, filed Jun. 25, 2004. The entire contents of the above application is incorporated herein by reference in its entirety.

### BACKGROUND OF THE INVENTION

Power converters are used to convert an input voltage having a first value to an output voltage having a second value which is typically different than the first value. The input voltage is applied to the primary side of the power converter while the output voltage is generated on the secondary side. Power converters often provide electrical isolation between the primary side voltage and secondary voltage while converting an input voltage to an output voltage.

Transformers are often used in power converters where the output voltage is isolated from the input voltage. Transformers typically have a primary winding for receiving the input voltage, a secondary winding for generating the output voltage and a magnetic core. The primary and secondary windings are wrapped around the core such that an input voltage is magnetically coupled to the secondary winding. Since no direct connection is made between the primary and secondary windings, the windings are referred to as being electrically isolated from one another. Transformers may be used in power converters providing alternating current-to-alternating current (AC-AC) power conversion, alternating current-to-direct current (AC-DC) power conversion, and direct current-to-direct current (DC-DC) power conversion.

DC-DC power conversion is employed in a myriad of industrial and consumer products ranging from air traffic control systems to cellular telephones. DC-DC converters may employ techniques for improving such things as conversion efficiency, voltage regulation, operating speed, minimizing circuit size, reducing electromagnetic interference, minimizing the number of electrical components, and minimizing per unit manufacturing costs.

Synchronous rectification is one such technique employed for improving the performance of DC-DC converters. A “synchronous rectifier,” as used in a power converter employing a transformer, may be defined as a circuit employing two or more switches, which are typically synchronized field effect transistors (FETs) or metal oxide field effect transistors (MOSFETs), as rectifying devices along with related drive circuitry to control the on-off cycling of the MOSFETs. A synchronous rectifier operates such that the switch is in the ON-state when the rectifier is conducting current and in the OFF-state when the rectifier is blocking voltage. MOSFETs serve as good synchronous rectifiers because they contain an intrinsic diode that allows them to behave as a normal rectifier.

The operating efficiency of the power converter, to a large extent, is dependent on the control of the synchronous rectifiers. Therefore, it is important that the synchronous rectifiers are turned on and off at predictable times over the entire operating range of the converter. Prior art techniques for controlling synchronous rectifiers may couple the drive, or gate, of a synchronous rectifier to the secondary winding of the transformer. This technique is termed cross coupling. Cross coupling may reliably work over a portion of the power converter's operating range; however, this scheme may not be sufficiently reliable at other portions of the operating range such as with low range input voltages on the primary side of the transformer. What is needed is a synchronous rectifier control method and power topology that addresses these and other problems in a simple, efficient, cost effective manner.

### SUMMARY OF THE INVENTION

Embodiments of the present invention improve the self-drive of synchronous rectifiers used in isolated power converters. A separate winding is added to the transformer and used to control the gate drive of the synchronous rectifiers which are MOSFETs in the exemplary embodiments used herein. This separate winding is referred to as a drive winding and it employs a turns ratio with respect to the primary winding. The drive winding is further designed to provide adequate and reliable gate voltages and/or current waveforms to the MOSFETs over substantially the entire operating range of the power converter. Embodiments of the invention not only provide better gate driving waveforms, but they also employ fewer components than is required to implement power converters having comparable output currents using common prior art implementations. Employing lower component counts allows embodiments of the invention to be fabricated in small packages, or footprints, and at lower costs as compared to typical prior art devices.

The foregoing and other features and advantages of the system and method for a self-drive for synchronous rectifiers will be apparent from the following more particular description of preferred embodiments of the system and method as illustrated in the accompanying drawings in which like reference characters refer to the same parts throughout the different views.

### BRIEF DESCRIPTION OF THE DRAWINGS

FIG. 1 illustrates a schematic representation for a system capable of converting a source voltage to an output voltage for application to a load in accordance with aspects of the invention;

FIGS. 2A-D illustrate exemplary embodiments of front ends that are useful when practicing aspects of the invention;

FIG. 3A contains a schematic diagram illustrating an exemplary embodiment of a back end that can be used with a front end providing an AC drive waveform;

FIG. 3B contains a timing diagram showing selected waveforms associated with the back end of FIG. 3A;

FIG. 3C illustrates an exemplary embodiment of the back end of FIG. 3A configured with a single secondary winding;

FIG. 3D contains a schematic diagram illustrating an exemplary embodiment of a back end that can be used with a front end providing a rectified waveform;

FIG. 3E contains a timing diagram showing selected waveforms associated with the back end of FIG. 3D;

FIG. 3F illustrates an exemplary embodiment of a back end that can be used for supplying substantially 30 amps at 12 volts into a load; and

FIG. 4 illustrates an exemplary method for using a signal received from a drive winding to drive a synchronous rectifier.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

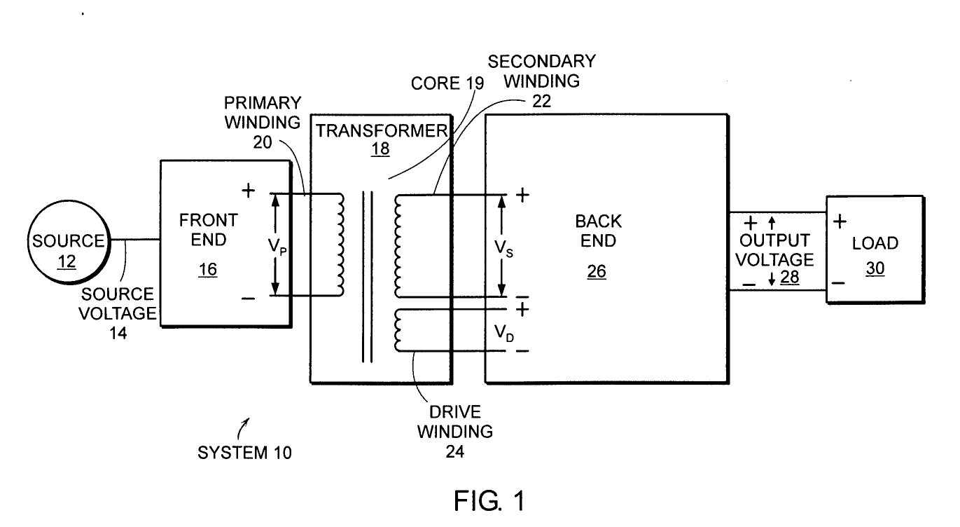

FIG. 1 illustrates a schematic representation of a system 10 for converting a source voltage to an output voltage. A source 12 supplies a source voltage 14 to a front end 16. The source provides direct current (DC) voltage waveform to front end 16. Front end 16 serves as an interface and waveform conversion device by converting the source voltage into a desired form for coupling into the primary winding 20 of transformer 18.

Waveforms present at the primary winding 20 are magnetically coupled to the secondary winding 22 and drive winding 24 using core 19. The secondary winding is coupled to back end 26 which consists of passive and active electrical components operating cooperatively to produce a desired regulated DC output voltage 28. Drive winding 24 is coupled to at least a subset of the components making up back end 26. In particular, drive winding 24 may be connected to the gates of synchronous rectifiers utilized in back end 26. Output voltage 28 is coupled to a load 30. Load 30 may be any type of component, device or system that uses DC voltage alone or in combination with AC voltage. Examples of loads are, but are not limited to, consumer and industrial devices such as kitchen equipment, electronic games, audio and video equipment, avionic subsystems, computers, communications equipment, control systems, and the like.

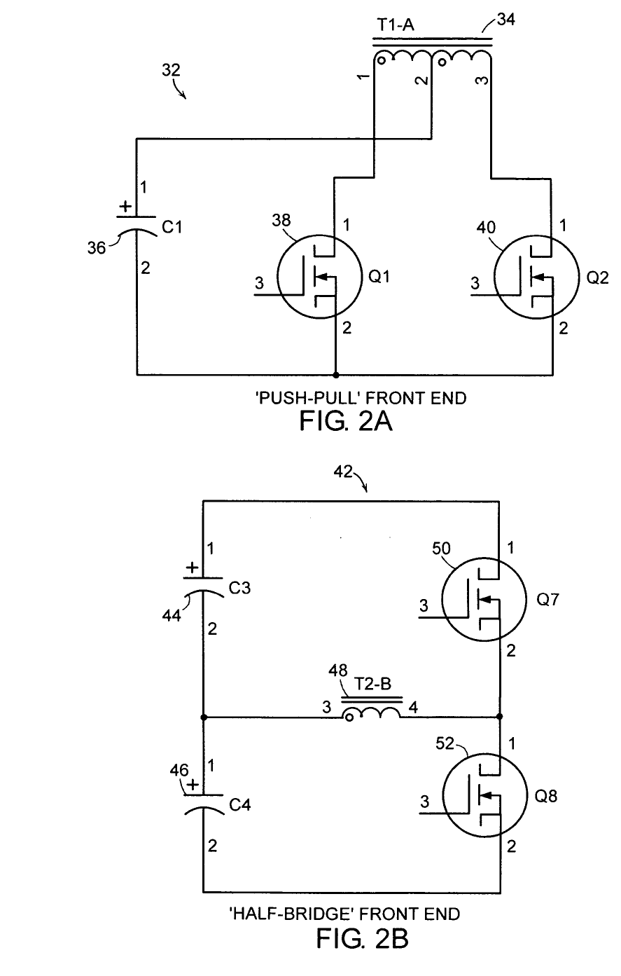

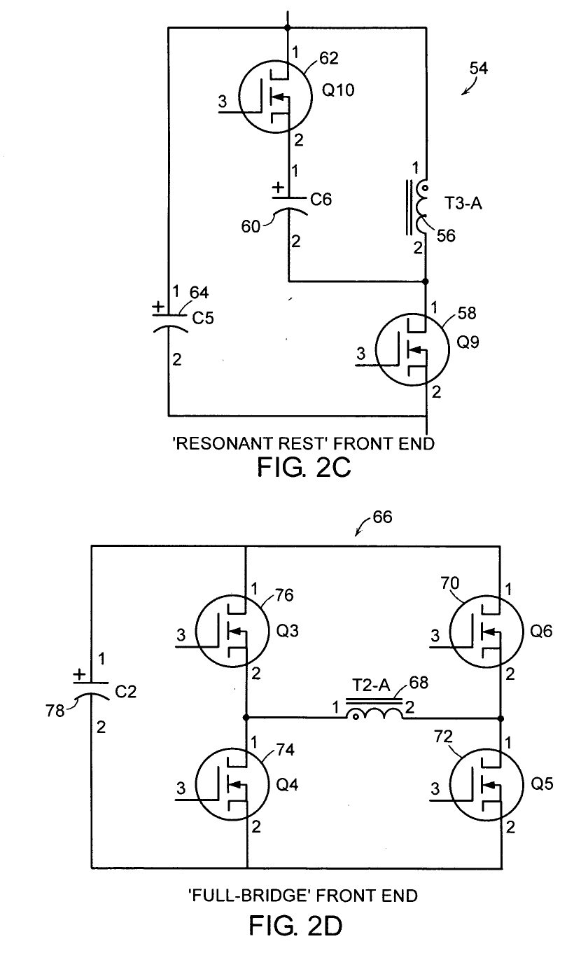

FIGS. 2A-D illustrate exemplary front ends that can be employed with a transformer 18 and back end 26. FIG. 2A illustrates a push-pull front end having a capacitor 36 connected to center tap 2 of transformer 34 and the power supply return. The drain node of MOSFET 38 is coupled to tap 1 of transformer 34 and the source node is connected to the power supply return. The drain node of MOSFET 40 is coupled to tap 3 of transformer 34 and the source node is connected to the power supply return. The input power source is connected across C36. The push-pull front end 32 operates by alternately conducting MOSFET 38 and MOSFET 40 for a percentage of the total period of conduction, T, called the duty-cyle. The alternating conduction causes the magnetic flux in the transformer core to have an AC value centered around a nominal zero DC flux condition allowing for greater utilization of the ferrite core.

FIG. 2B illustrates a half-bridge front end 42 having capacitor 44 coupled to tap 3 of transformer 48, the drain lead of MOSFET 50 and the positive side of a power source (not shown), capacitor 46 coupled to tap 3 of transformer 48, the source of MOSFET 52 and the return of a power source (not shown). Tap 4 of transformer 48 is coupled to the source of MOSFET 50 and drain of MOSFET 52. The input power source is connected across the series connection of C44 and C46. The half-bridge front end 42 operates by alternately conducting MOSFET 50 and MOSFET 52 so that the average voltage across the winding is zero and the average current into the capacitors is zero. The nominal voltage applied across the winding during one conduction period is generally half the input voltage applied across the series connected capacitor 44 and capacitor 46. The maximum utilization of transformer flux is similar to the push pull. Because only half of the input voltage is applied, the current is generally double the value for the same power delivery to the secondary.

FIG. 2C illustrates an exemplary resonant reset front end 54 including a MOSFET 58 coupled to capacitor 60 and tap 2 of transformer 56 by way of MOSFET 58 drain and further coupled to capacitor 64 by way of MOSFET 58 source. The resonant reset front end 54 further includes MOSFET 62 which is coupled to tap 1 of transformer 56 by way of its drain and further coupled to capacitor 60 by way of its source. Resonant reset front end 54 operates by allowing the alternate conduction of MOSFET 58 and MOSFET 62. During the conduction of MOSFET 58 the power can flow from the input to the output directly through the transformer (called a ‘forward converter’ connection). During the conduction of MOSFET 62 the power can flow from capacitor C60 to the output. Capacitor C60 obtains the correct voltage needed to perfectly balance the flux because in the cyclic steady-state the average current into C60 must be zero. Energy stored in T3 in the form of magnetizing current can be delivered to the load during the conduction of MOSFET 62.

FIG. 2D illustrates a full bridge front end 66 including transformer 68 having a tap 1 coupled to the source of MOSFET 76 and drain of MOSFET 74, respectively. Transformer 68 is further coupled to the source of MOSFET 70 and drain of MOSFET 72 by way of tap 2. Capacitor 78 is coupled to the drain of MOSFET 76 and MOSFET 70 by way of lead 1 and is further coupled to the source of MOSFET 74 and MOSFET 72 by way of lead 2. The input power source is connected across capacitor C78. The operation of this converter can use several switching sequence schemes, one of which is described. MOSFET 76 and MOSFET 72 are conducted simultaneously and MOSFET 74 and MOSFET 70 are conducted simultaneously such that the pairs of MOSFETs are alternately conducted. During the conduction of MOSFET 76 and MOSFET 72 the C2 voltage is applied across T68. During the conduction of MOSFET 74 and MOSFET 70 an opposite polarity voltage is applied across T68 satisfying the requirement that the average voltage across the winding is zero. During each of these conduction periods power can be delivered through the transformer.

Transformer 18 couples front end 16 to back end 26. Transformer 18 provides electrical isolation between the signals applied to the primary side 20 and signals output from the secondary side 22. Transformer 18 maybe fabricated using materials, techniques and processes known in the art. By way of example, transformer 18 may consist of primary and secondary windings made of insulated wire and wrapped around a core consisting of a material having magnetic properties. Alternatively, transformer 18 may be fabricated using planar windings consisting of thin copper plates or sheets, or foils, and separated by an insulator. A planar configuration may also include one or more interconnects passing through and in electromechanical contact with one or more copper plates. Still other exemplary embodiments of transformer 18 may consist of a combination of wire windings, plates or foils, or layers of conductive particles interspersed with insulative materials to form a hybrid transformer.

In addition to being made of many possible compositions of materials, transformer 18 may have many form factors. By way of example, transformer 18 may be fabricated as a stand alone unit and electromechanically coupled to front end 16 and back end 26 by way of leads. Alternatively, transformer 18 may be potted in materials that aid with heat dissipation, immunity to mechanical vibration, and/or protection from ambient environmental parameters such as humidity, condensed water vapor, temperature, ultraviolet radiation, and the like. In still another alternative embodiment, transformer 18 may be mounted on or be integral with an integrated circuit (IC) board, such as, for example, in an open frame configuration. Transformer 18 may be electromechanically coupled to an IC board by way of through hole mountings, press fit sockets, welding, brazing, or screw mounting.

Transformer 18 as used in embodiments of the present invention includes at least one drive winding 24 in addition to the primary winding 20 and secondary winding 22. Drive winding 24 is magnetically coupled to primary winding 20 in a preferred embodiment; however, drive winding 24 may be coupled to secondary winding 22 or, alternatively, with primary winding 20 and secondary winding 22. A turns ratio between primary winding 20 and drive winding 24 is used to establish a defined drive voltage V_{D} over an anticipated range of voltages on the primary winding, herein referred to as primary voltage V_{P} and primary winding waveforms.

By employing drive winding 24, the drive voltage V_{D} is independent of the voltage on the secondary winding, herein referred to as secondary voltage V_{S}. Drive winding 24 provides a circuit designer with the flexibility to design back end 26 in a manner that ensures synchronous rectifiers used therein will have drive voltages V_{D} of sufficient amplitude to reliably and deterministically drive the gates on the synchronous rectifiers such that the devices operate in an optimal manner.

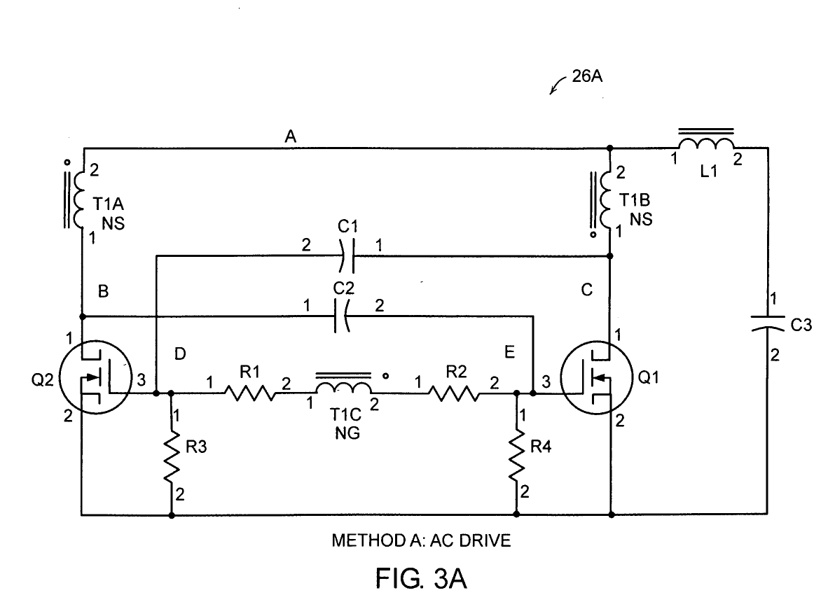

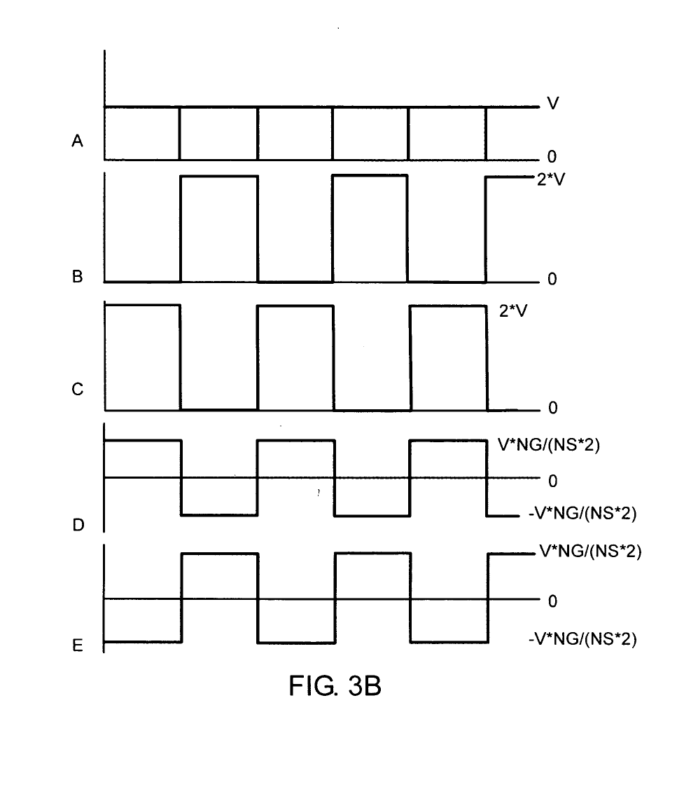

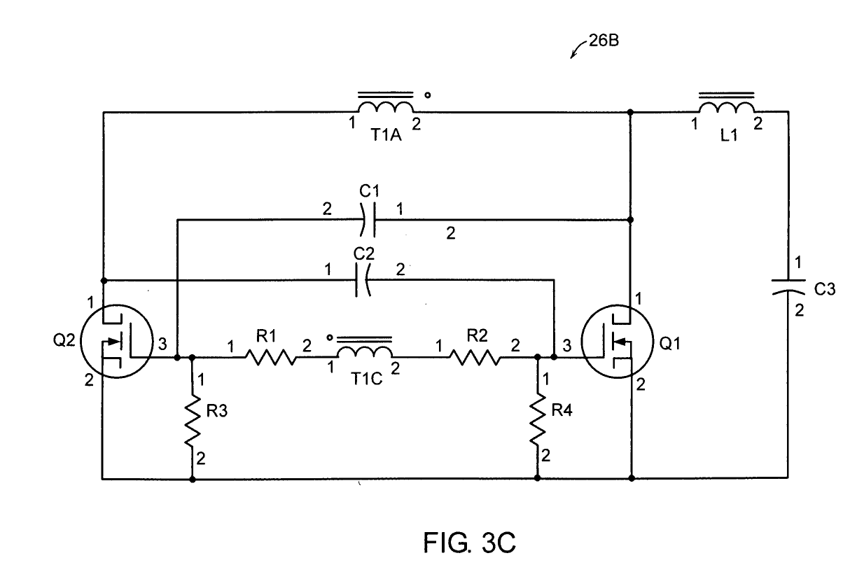

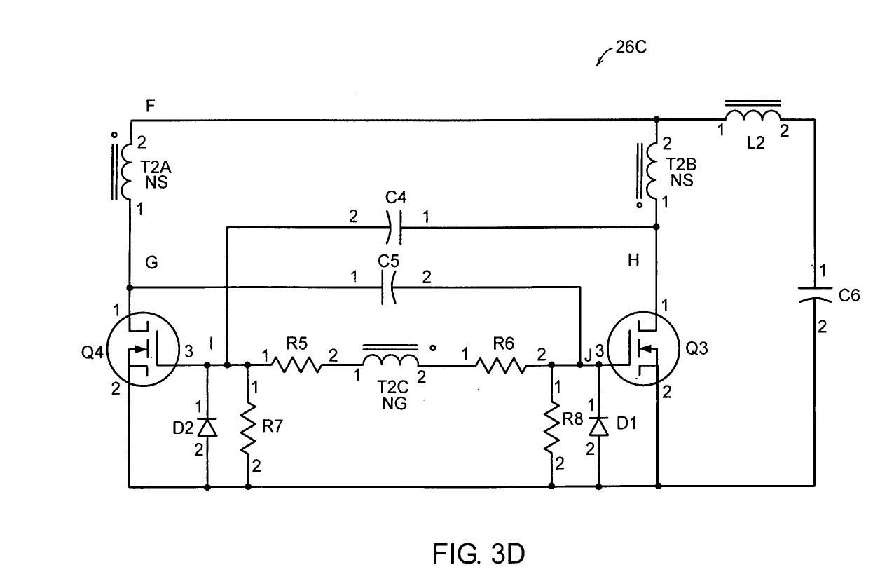

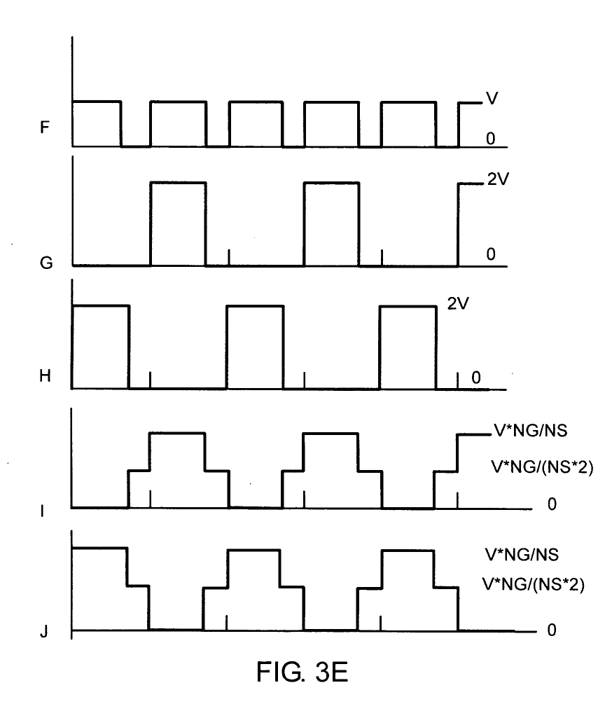

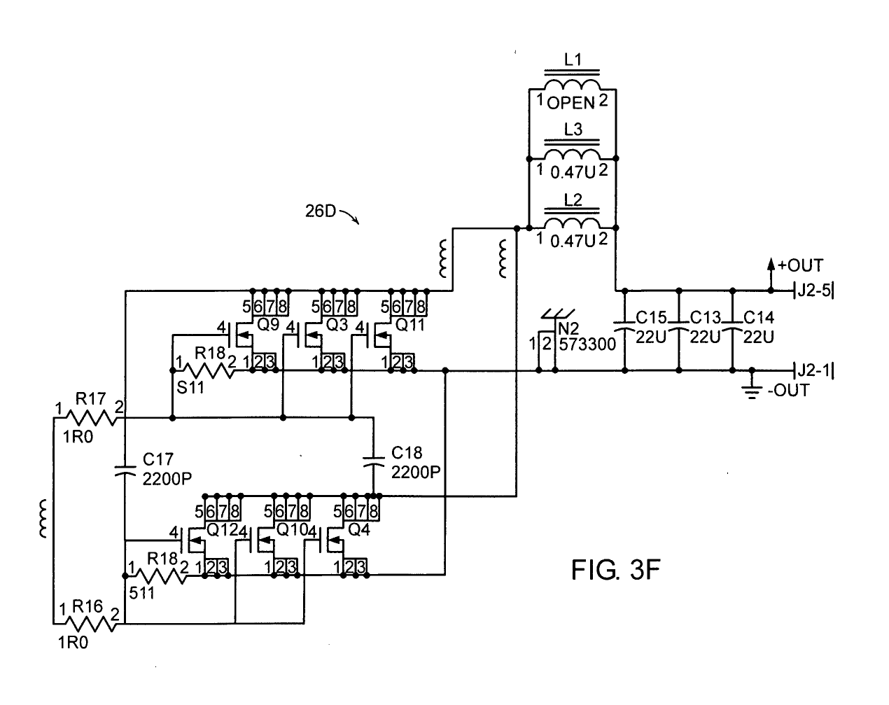

FIG. 3A illustrates a schematic diagram of an exemplary embodiment of a back end 26A employing a self-drive utilizing a drive winding 24. Back end 26A includes secondary windings T1A and T1B which are magnetically coupled to a primary winding 20. Back end 26A further includes MOSFETS Q1 and Q2, respectively, capacitors C1, C2 and C3, resistors R1, R2, R3 and R4, inductor L1 and drive winding TIC.

Secondary winding T1A is coupled to secondary winding T1B, to L1, to the drain of Q2, and to C2. Secondary winding T1B is coupled to C1 and the drain of Q1. The gate of Q2 is coupled to C 1, R3 and R1, the source of Q2 is coupled to R3, R4, the source of Q1, C3 and to ground. Drive winding TIC is coupled to R1 and R2. The gate of Q1 is coupled to C2, R4 and R2. Capacitor C3 is connected in parallel with load 30 by way of being coupled to L1 and ground.

The gates of Q1 and Q2 have capacitative characteristics that when connected to a winding having a series inductance can form an LC circuit. If such a circuit is formed and the LC response is left undamped, voltage overshoot may occur at the gate of Q1 and Q2. Embodiments of the invention employ series resistors to critically damp the signals driving the gates of Q1 and Q2. Critically damped signals present at the gates of Q1 and Q2 do not exhibit voltage overshoot or undershoot which facilitates predictable operation of power converters employing embodiments of the invention.

Capacitors C1 and C2 may be employed to counteract the internal capacitance of Q1 and Q2 which is referred to as the Miller capacitance associated with the gate and drain of the MOSFETs Q1 and Q2. The Miller capacitance inhibits the switching speed of Q1 and Q2 if not compensated for using, for example, C1 and C2. In a preferred embodiment, values of C1 and C2 are selected such that

$$C1 = C2 = \frac{Qgd}{2 * V} \qquad Eq . 1$$

where Qgd is gate-drain charge and can be found in a manufacturer's data sheet for a particular MOSFET used for Q1 or Q2, and 2*V is the input voltage to back end 26A which is obtained from secondary winding T1. Values for C1 and C2 that vary from the value obtained by equation 1 may not adversely impact operation of 26A so long as the variation is not large. Series resistors may be used with C1 and C2 if desired. If used, the series resistors should have small resistance values.

R1 and R2 are used in series with the gates of Q2 and Q1, respectively, to dampen resonances that may occur as a result of leakage inductances associated with drive winding T1C and the gate capacitances of Q1 and Q2. In a preferred embodiment, the values of R1 and R2 are selected such that

$$R1 ≅ R2 ≅ ) \overline{\frac{Leakage inductance of T1C}{gate capacitance of Q1 or Q2}} \qquad Eq . 2$$

A value for R1 or R2 that varies from results obtained using equation 2 may not adversely impact the operation of back end 26A. In an alternative embodiment of back end 26A, R1 does not have to equal R2. For example, R1 can be replaced with a value of zero ohms and R2 can be made twice as large.

R3 and R4 are employed to ensure that the average values of the gates of Q2 and Q1, respectively, are zero volts. In addition, R3 and R4 prevent Q2 and Q1 from turning on if back end 26A is powered by an external voltage across C3. In an alternative embodiment of back end 26A, R3 and R4 can be coupled to the other side of R1 and R2, respectively, and ground.

Inductor L1 operating in conjunction with C3 filters the rectified waveform at “A” (see FIG. 3B) to produce a DC output voltage.

Back end 26A is designed to ensure that where “B” (see FIG. 3B) has a voltage at the high state, namely 2*V, the gate drive voltage of Q2 will be less than the MOSFET threshold voltage. Likewise, back end 26A will have the gate drive voltage for Q1 at a value less than the MOSFET threshold voltage when the voltage at “C” (see FIG. 3B) is at the high state. Back end 26A is further designed to ensure that the drive voltage for the gate of Q2 exceeds the MOSFET threshold voltage sufficiently to minimize losses in Q2 when the voltage at “B” is in the low state, namely zero volts. Likewise, back end 26A is designed such that when the voltage at “C” is in the low state the drive voltage for the gate of Q1 exceeds the MOSFET threshold voltage.

Back end 26A facilitates the use of optimized waveforms for driving the gates of Q1 and Q2 because the gate drive waveforms are not cross coupled to the power windings of transformer 18 as is done in certain prior art implications of self-drive techniques for synchronous rectifiers.

FIG. 3B illustrates exemplary waveforms present at selected locations within back end 26A as described in conjunction with FIG. 3A, namely locations A, B, C, D, E. The waveform at location A represents the output voltage of back end 26A. Waveforms B and C represent the voltages present at secondary windings T1A and T1B, respectively. The waveforms at B and C have values ranging from 0 volts to 2*V volts. The waveforms at locations D and E represent signals present at the gates of MOSFETs Q2 and Q3, respectively. The waveforms at D and E, respectively, vary from

$$- \frac{V * NG}{( NS * 2 )} to + \frac{V * NG}{( NS * 2 )} .$$

FIG. 3C illustrates an embodiment of back end 26B that employs a single secondary winding T1A in place of the dual secondary windings utilized in the embodiment shown in FIG. 3A.

FIG. 3D illustrates an exemplary embodiment of back end 26C utilizing a rectified drive. The embodiment of FIG. 3D includes a dual winding secondary T2A, T2B, a drive winding T2C, an inductor L2, load capacitor C6, capacitors C4 and C5, MOSFETS Q3 and Q4, resistors R5, R6, R7 and R8, in a configuration paralleling that of FIG. 3A. In addition, back end 26C further employs diode D1 and D2.

Back end 26C operates in a manner similar to that of back end 26A; however, some differences between the two embodiments are present. For example, the gate drive waveforms are rectified and are driven from 0 volts to V*NG/NS, where NG is the number of turns associated with drive winding T2C, and NS is the number of turns associated with secondary windings T2A, T2B as opposed to the gate drive signals for Q1 and Q2 which were driven from

$$+ \frac{V * NG}{( NS * 2 )} to - \frac{V * NG}{( NS * 2 )} .$$

The embodiment of FIG. 3D is useful for applications operating over less than high duty cycle power conversion. In FIG. 3D, the interval when both MOSFETS can conduct is referred to as the “overlap.” During overlap, the gate voltage is

$$\frac{V * NG}{( NS / 2 )} .$$

This gate voltage is sufficient to allow the MOSFETs to be conducting current in a low loss manner, which improves the efficiency of back end 26C as compared to prior art implementations. The embodiment of FIG. 3D may be configured such that both Q3 and Q4 are conducting during deadtime if desired. Having Q3 and Q4 conducting simultaneously may be beneficial in some applications.

Embodiments of the invention described hereinabove avoid the use of clamping diodes in conjunction with the gate drives of Q1, Q2, Q3 and Q4, respectively, in order to avoid potentially detrimental impacts on the performance of the respective gate drive signals. Embodiments of the invention further eliminate the potentially detrimental effects on circuit performance which can occur when zener diodes are employed. For example, in certain circumstances, the use of zener diodes may facilitate clamping of the secondary winding with a zener voltage that is less than the open circuit voltage of the winding. This situation can lead to the destruction of the zener diode and subsequent malfunction of the circuit.

FIG. 3E illustrates exemplary waveforms present at selected locations within back end 26C, namely locations F, G, H, I, J. The waveform at F represents the output waveform of back end 26C which varies from 0 volts to +V colts. Waveforms G and H represent the rectified waveforms present at secondary windings T2A and T2B, respectively. Waveforms I and J represent the gate drive waveforms for MOSFETs Q4 and Q3, respectively.

FIG. 3F contains a schematic diagram of an exemplary embodiment of a back end 26D that can be implemented in an industry standard ¼ brick format as a 12 volt supply delivering 30 amps to a load 30. For example, the embodiment of FIG. 3F may include the following components shown in Table. 1.

TABLE 1

| Component ID | Manufacturer | Part Number/Description |
|---|---|---|
| Q10, Q11, Q12, Q3, Q4, | International | IRF7842 |
| Q9 | Rectifier | SMD MOSFET N-channel |
| | | S08 |
| L, L2, L3 | Inter-Technical | SC7232-R47M |
| | | SMD Power Inductor 7030 |
| C13, C14, C15 | TDK | C3225X5R1C226MT |
| | | SMD CAP 1210X5R |
| C17, C18 | TDK | C2012X5R1A225K |
| | | SMD CAP 0805X7R |
| R15, R18 | Dale | CRCW06035110FT |
| | | SMD Resistor |
| R16, R17 | KOA | RK73H1JT1R00FT |
| | | SMD Resistor |

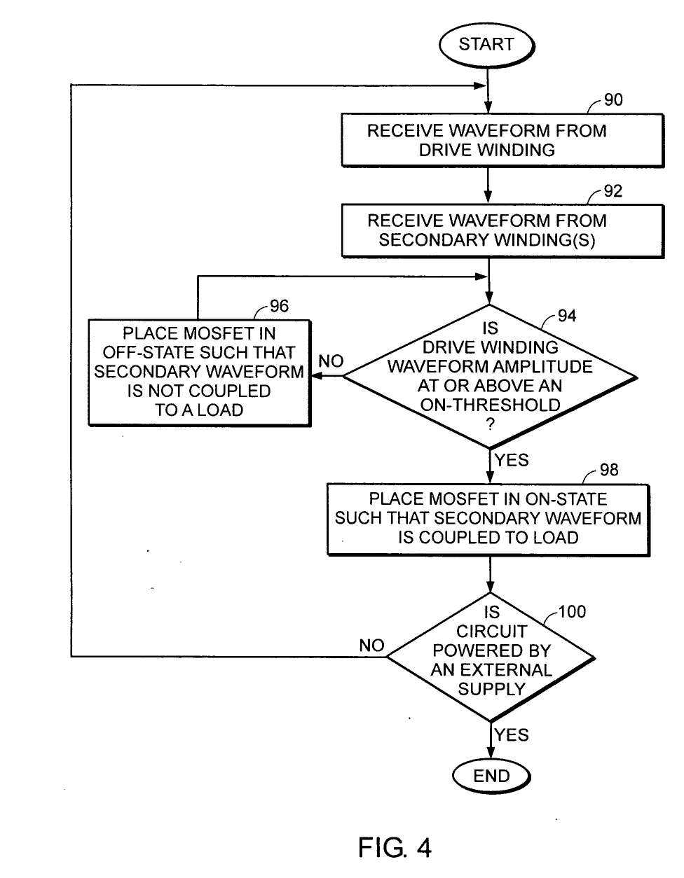

FIG. 4 illustrates an exemplary method by which embodiments of the invention may operate. The method starts when a waveform is received from drive winding 24 (per step 90). The method also receives a waveform from one or more secondary windings 22 (per step 92). A determination is made to determine if the amplitude of the waveform received from the drive winding is above a threshold (per step 94). The threshold can be set at a level to ensure reliable operation of back end 26 over its entire generating range. If the drive waveform is at or above the threshold value, one or more MOSFETs coupled thereto may be placed in an ON-state (per step 98). When in an ON-state, the MOSFETs are able to conduct current that can be supplied to a load. If the amplitude of the drive waveform does not exceed the threshold level, MOSFETs coupled thereto are kept in an OFF-state (per step 96). When a MOSFET is in an OFF-state, it does not conduct significant amounts of current that can be utilized by a load.

After step 96 the method loops back to the input of step 94. The method may include a decision block that determines if back end 26 is coupled to an external power supply (per step 100). If back end 26 is coupled to an external supply, the method may terminate in that it no longer has to utilize drive waveforms or secondary waveforms for supplying power to a load. If back end 26 is not coupled to an external power supply, the flow may loop back to step 90.

Embodiments of the invention may be constructed to fit particular form factors such as industry standard ⅛, ¼ brick or ½ brick formats. In addition, components used in power converters such as those illustrated in FIGS. 3A, 3C, 3D and 3F may be constructed from surface mount technology (SMT) and used to facilitate power converters that are small in size. The MOSFETs used in preferred embodiments discussed herein may be replaced with junction field effect transistors (JFETs) or similar devices known and used in the art. Embodiments of the invention may further be incorporated into products containing the load or embodiments of the invention may be self-contained and coupled to a load by way of wires and/or connectors. In addition, circuit and application designers can use computer-driven design and simulation tools such as Spice™ for designing and testing circuits such as those illustrated in FIGS. 3A, 3C, 3D and 3F.

As seen by the embodiments described hereinabove, the invention is not limited to a particular size, component layout, or by way of the types of components used.

The claims should not be read as limited to the described order or elements unless stated to that effect. Therefore, all embodiments that come within the scope and spirit of the following claims and equivalents thereto are claimed as the invention.

1. A power converter comprising:
a first switch;
a second switch;
a transformer comprising:
a primary winding for receiving an input voltage waveform;
a secondary winding for providing a secondary voltage waveform to said first switch and said second switch;
a drive winding operatively coupled to said first switch and said second switch for facilitating formation of a rectified voltage waveform; and
a compensation module compensating for at least one of a first capacitance associated with said first switch and a second capacitance associated with said second switch.

2. The power converter of claim 1 wherein said first switch and said second switch are metal oxide semiconductor field effect transistors (MOSFETs).

3. The power converter of claim 2 wherein said drive winding is magnetically coupled to said primary winding by way of a turns ratio.

4. The power converter of claim 3 wherein said drive winding is operatively coupled to a first gate associated with said first MOSFET and is further operatively coupled to a second gate associated with said second MOSFET, said drive winding further configured to operate said first and second MOSFETs such that a rectified output is made available.

5. The power converter of claim 4 wherein said primary winding is operatively coupled to a front end selected from the group consisting of a half-bridge front end, a resonant reset front end, a push-pull front end and a full bridge front end.

6. The power converter of claim 4 wherein said secondary winding is operatively coupled to a first drain of said first MOSFET and is further operatively coupled to a second drain of said second MOSFET.

7. The power converter of claim 6 further comprising an output terminal which is coupled to a load.

8. The power converter of claim 3 wherein said transformer is of a planar configuration.

9. The power converter of claim 2 wherein said MOSFETs are of a surface mount technology (SMT).

10. The power converter of claim 1 wherein said first switch and said second switch are junction field effect transistors (JFETs), respectively.

11. A power converter comprising:
a first MOSFET having a first gate, a first drain, and a first internal capacitance;
a second MOSFET having a second gate, a second drain, and a second internal capacitance;
a transformer, comprising:
a core consisting of a magnetizeable material;
a primary winding for receiving an input voltage waveform from a front end;
a secondary winding magnetically coupled to said primary winding using said magnetizeable core, said secondary winding producing a secondary voltage waveform, said secondary voltage waveform coupled to said first drain and said second drain for producing an output voltage for driving a load; and
a drive winding magnetically coupled to said primary winding using said magnetizeable core, said drive winding producing a drive waveform for operating said first and second gates in a manner causing said MOSFETS to operate cooperatively for driving a load.

12. The power converter of claim 11 further comprising a plurality of resistors and a plurality of capacitors operatively coupled to said first and second MOSFETs to facilitate driving said load.

13. The power converter of claim 12 wherein a subset of said resistors compensates for said first and second internal capacitances, respectively.

14. The power converter of claim 13 wherein said first capacitance is a first Miller capacitance and said second capacitance is a second Miller capacitance.

15. The power converter of claim 11 wherein said transformer is a planar configuration.

16. The power converter of claim 11 wherein said primary winding is coupled to a front end selected from the group consisting of a half bridge front end, a resonant reset front end, a push-pull front end and a full bridge front end.

17. A method for providing a rectified output to a load comprising the steps of:
receiving a secondary waveform from a secondary winding associated with a transformer;
receiving a drive waveform from a drive winding associated with said transformer, said drive winding further magnetically coupled to a primary winding; and
using said drive waveform to drive a plurality of MOSFETs in a cooperative manner for producing said rectified output in cooperation with said secondary waveform, said drive waveform placing at least one member of said plurality in an ON-state when said drive waveform exceeds a threshold value.

18. The method of claim 17 wherein said transformer is of a planar configuration.
